(19) United States
(12) Patent Application Publication
(10) Pub. No.: US 2025/0251601 A1
(43) Pub. Date: Aug. 7, 2025

(54) PERSONAL IMMERSIVE DISPLAY APPARATUS AND DRIVING METHOD THEREOF

(71) Applicant: LG Display Co., Ltd., Seoul (KR)

(72) Inventors: Jong Ho JEONG, Paju-si (KR); Woong Jin SEO, Paju-si (KR)

(21) Appl. No.: 18/936,112

(22) Filed: Nov. 4, 2024

(30) Foreign Application Priority Data
Feb. 2, 2024 (KR) 10-2024-0016717

(51) Int. Cl. G02B 27/01; G09G 3/00; H04N 13/344; H04N 13/398

(52) U.S. Cl. CPC G02B 27/0172; G09G 3/003; H04N 13/344; H04N 13/398; G02B 2027/0134; G02B 2027/014; G02B 2027/0178; G09G 2354/00

(57) ABSTRACT

A personal immersive display apparatus includes a left-eye display configured to display a left-eye image and a right-eye display configured to display a right-eye image, wherein a left-eye active time where the left-eye image is written in the left-eye display is asynchronized with a right-eye active time where the right-eye image is written in the right-eye display.

### CROSS-REFERENCE TO RELATED APPLICATIONS

This application claims the benefit of the Korean Patent Application No. 10-2024-0016717 filed on Feb. 2, 2024, which is hereby incorporated by reference as if fully set forth herein.

### BACKGROUND

### Technical Field

The present disclosure relates to a personal immersive display apparatus and a driving method thereof.

### Description of the Related Art

Virtual reality (VR) technology is applied to the fields of national defense, architecture, tour, movie, multimedia, and game. VR denotes a specific environment and situation which are felt similar to a real environment by using stereoscopic image technology. To maximize the immersion of VR, VR technology is applied to personal immersive display apparatuses. Head-mounted display (HMD), face-mounted display (FMD), and eye glasses-type display (EGD) are representative apparatuses to which a personal immersive display apparatus is applied.

Personal immersive display apparatuses include a left-eye display which displays a left-eye image and a right-eye display which displays a right-eye image.

### BRIEF SUMMARY

The present disclosure may provide a personal immersive display apparatus and a driving method thereof, which may, among others, decrease flickers.

As embodied and broadly described herein, a personal immersive display apparatus includes a left-eye display configured to display a left-eye image and a right-eye display configured to display a right-eye image, wherein a left-eye active time where the left-eye image is written in the left-eye display is asynchronized with a right-eye active time where the right-eye image is written in the right-eye display.

In another aspect of the present disclosure, a driving method of a personal immersive display apparatus includes a step of displaying a left-eye image by using a left-eye display and a step of displaying a right-eye image by using a right-eye display, wherein a left-eye active time where the left-eye image is written in the left-eye display is asynchronized with a right-eye active time where the right-eye image is written in the right-eye display.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an exploded perspective view illustrating a personal immersive display apparatus according to the present disclosure;

FIG. 2 is a diagram illustrating first and second display panels in a display module illustrated in FIG. 1;

FIG. 3 is a diagram illustrating a distance between the first and second display panels illustrated in FIG. 2;

FIGS. 4 and 5 are diagrams illustrating flickers which occur because an image write time of a left-eye display is synchronized with an image write time of a right-eye display, in a comparative example;

FIG. 6 is a diagram illustrating a configuration of a first embodiment for reducing flickers;

FIGS. 7 and 8 are diagrams illustrating an example where a left-eye active time and a right-eye active time are asynchronized with each other by a time difference equal to a certain time therebetween, in an embodiment;

FIG. 9 is a diagram illustrating an example where flickers are reduced because a left-eye active time is asynchronized with a right-eye active time;

FIGS. 10 and 11 are diagrams illustrating an implementation example of a delay circuit of FIG. 6;

FIG. 12 is a diagram illustrating a configuration of a second embodiment for reducing flickers; and

FIGS. 13 and 14 are diagrams illustrating an example where left-eye and right-eye displays are driven at different frame frequencies.

### DETAILED DESCRIPTION

Hereinafter, the present disclosure will be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

The shapes, sizes, ratios, angles, numbers and the like disclosed in the drawings for description of various embodiments of the present disclosure to describe embodiments of the present disclosure are merely exemplary and the present disclosure is not limited thereto. Like reference numerals refer to like elements throughout. Throughout this specification, the same elements are denoted by the same reference numerals. As used herein, the terms “comprise”, “having,” “including” and the like suggest that other parts can be added unless the term “only” is used. As used herein, the singular forms “a”, “an”, and “the” are intended to include the plural forms as well, unless context clearly indicates otherwise.

Elements in various embodiments of the present disclosure are to be interpreted as including margins of error even without explicit statements.

In describing a position relationship, for example, when a position relation between two parts is described as “on˜”, “over˜”, “under˜”, and “next˜”, one or more other parts may be disposed between the two parts unless “just” or “direct” is used.

It will be understood that, although the terms “first”, “second”, etc., may be used herein to describe various elements, these elements should not be limited by these terms. These terms are only used to distinguish one element from another. For example, a first element could be termed a second element, and, similarly, a second element could be termed a first element, without departing from the scope of the present disclosure.

In the following description, when the detailed description of the relevant known function or configuration is determined to unnecessarily obscure the important point of the present disclosure, the detailed description will be omitted. Hereinafter, embodiments of the present disclosure will be described in detail with reference to the accompanying drawings.

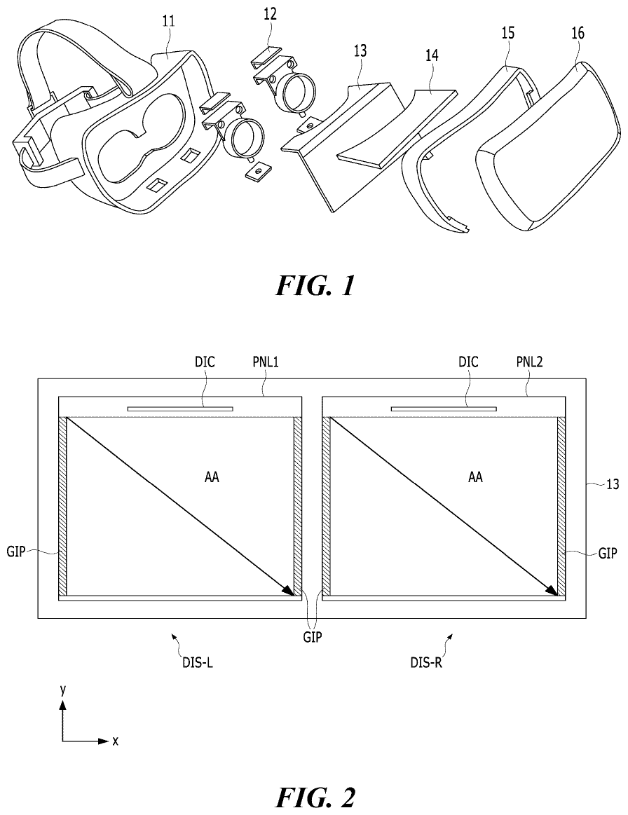

Referring to FIG. 1, a display apparatus according to the present disclosure may be a personal immersive display apparatus. The personal immersive display apparatus may include a lens module 12, a display module 13, a main board 14, a head gear 11, a side frame 15, and a front cover 16.

The display module 13 may include a display panel driving circuit for driving each of two display panels and may display an input image received from the main board 14. The display panels may be divided into a first display panel which is seen with a left eye of a user and a second display panel which is seen with a right eye of the user. The display module 13 may display image data input from the main board by using the display panels. The image data may be two-dimensional (2D)/three-dimensional (3D) image data which implements a video image of virtual reality (VR) or augmented reality (AR). The display module 13 may display various information, input from the main board, in the form of tests or signs.

The lens module 12 may include a super wide lens (i.e., a pair of fisheye lenses) for widening a left-eye angle of view and a right-eye angle of view of the user. The pair of fisheye lenses may include a left-eye lens disposed in front of the first display panel and a right-eye lens disposed in front of the second display panel.

A camera for photographing an eye-gaze focus of the user may be disposed in the lens module 12. The camera may photograph both eyes of the user and may transmit photographed information to a processor.

The main board 14 may include a processor which executes VR software and supplies a left-eye image and a right-eye image to the display module 13.

The main board 14 may further include a sensor module and an interface module connected to an external device. The interface module may be connected to the external device through an interface such as a universal serial bus (USB) or a high definition multimedia interface (HDMI). The sensor module may include various sensors such as a gyro sensor and an acceleration sensor.

In response to an output signal of the sensor module, the processor of the main board 14 may correct left-eye and right-eye image data and may transmit left-eye and right-eye image data of the received input image to the display module 13 through the interface module. The processor may generate a left-eye image and a right-eye image suitable for a resolution of the display panel, based on a depth information analysis result of a 2D image, and may transmit the left-eye image and the right-eye image to the display module 13. The processor may transmit, to the display module 13, a left-eye timing control signal for controlling a display timing of the left-eye image and a right-eye timing control signal for controlling a display timing of the right-eye image.

The head gear 11 may include a back cover which exposes fisheye lenses and a band which is connected to the back cover. The back cover of the head gear 11, the side frame 15, and the front cover 16 may be assembled, and thus, may secure an internal space where elements of the personal immersive display apparatus are disposed and may protect the elements. The elements may include a lens module 12, a display module 13, and a main board 14. The band may be connected to the back cover. The user may wear the personal immersive display apparatus on a head of the user. When the user wears the personal immersive display apparatus on the head of the user, the user may see different display panels with the left eye and the right eye by using the fisheye lenses.

The side frame 15 may be fixed between the head gear 11 and the front cover 16 and may secure a gap of an internal space where the lens module 12, the display module 13, and the main board 14 are disposed. The front cover 16 may be disposed on a front surface of the personal immersive display apparatus.

The personal immersive display apparatus may be implemented in a head-mounted display (HMD) as in FIG. 1, but is not limited to FIG. 1. For example, the present disclosure may be designed as an eye glasses-type display (EGD) having a glasses structure.

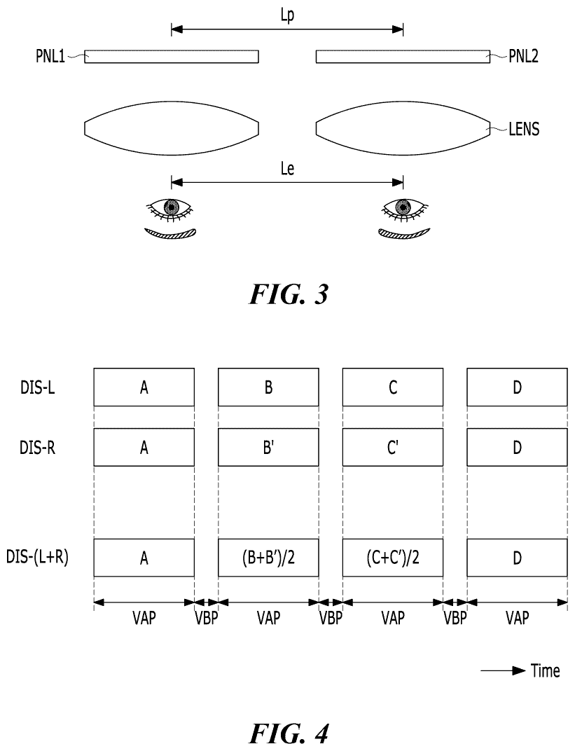

FIG. 2 is a diagram illustrating first and second display panels in a display module illustrated in FIG. 1. FIG. 3 is a diagram illustrating a distance between the first and second display panels illustrated in FIG. 2.

Each of first and second display panels PNL1 and PNL2 may be implemented as an organic light emitting diode (OLED) display panel which is fast in response time and good in color reproduction characteristic and has a wide viewing angle characteristic. In EGD, each of the first and second display panels PNL1 and PNL2 may be implemented as a transparent OLED display panel.

Referring to FIGS. 2 and 3, the first and second display panels PNL1 and PNL2 may be separately manufactured and may be disposed apart from each other in the display module 13.

A drive integrated circuit (IC) (DIC) may be an IC chip where a timing controller and a data driver are integrated. A gate in panel (GIP) may correspond to a gate driver and may output a scan signal and an emission (EM) signal. The GIP may be integrated on the same substrate along with a pixel array.

A distance Lp between a pixel array center of the first display panel PNL1 and a pixel array center of the second display panel PNL2 may be set to Le±α. A distance Le between both eyes of a user may be a distance between a left-eye pupil and a right-eye pupil and may be about 6.5 cm (=65 mm), and based on race, there may be a slight difference. Here, a may be a design margin based on a process deviation and a display panel driving circuit portion disposed between the first and second display panels PNL1 and PNL2 and may be set to 10% of the distance Le.

A pixel array AA of each of the first and second display panels PNL1 and PNL2 may have a screen ratio of a landscape type where a length in a horizontal direction x is longer than a length in a vertical direction y, based on a vertical viewing angle and a horizontal viewing angle. In the personal immersive display apparatus, when the horizontal viewing angle is wider than the vertical viewing angle, an effect of improving a viewing angle may be large. In the personal immersive display apparatus, each of the first and second display panels PNL1 and PNL2 may be manufactured as an OLED display panel of a landscape type, so as to increase the horizontal viewing angle.

In a screen ratio of a landscape type, the number of pixels in the horizontal direction x may be more than the number of pixels in the vertical direction y, and a length in the horizontal direction x may be longer than the length in the vertical direction y. Also, in a screen ratio of a portrait type, the number of pixels in the vertical direction y may be more than the number of pixels in the horizontal direction x, and a length in the vertical direction y may be longer than the length in the horizontal direction x.

In the personal immersive display apparatus, the left-eye pupil of the user may match the center of the first pixel array, and the right-eye pupil of the user may match the center of the second pixel array. When pixel arrays of the first and second display panels PNL1 and PNL2 are separated from each other and a distance between centers of the pixel arrays matches the left eye and the right eye, a viewing angle may be wide, and an effect of improving three-dimensionality may be large.

Three-dimensionality felt by the user may be better in a screen ratio of a landscape type than a screen ratio of a portrait type. The present disclosure may divisionally place a left-eye display panel and a right-eye display panel of a landscape type in the personal immersive display apparatus, and thus, three-dimensionality may increase.

A first pixel array AA displaying a left-eye image and a second pixel array AA displaying a right-eye image may be disposed at 1:1 in substrates separated from each other so that the first pixel array AA is separated from the second pixel array AA. In this case, the first pixel array AA may be disposed on a substrate of the first display panel PNL1, and the second pixel array AA may be disposed on a substrate of the second display panel PNL2.

In another embodiment, first and second pixel arrays may be separated from each other in one substrate. In this case, the pixel arrays may be separated from each other in one display panel. Here, the pixel arrays being separated from each other may denote that a data line, a gate line (or a scan line), and pixels are separated from one another. Although the first and second pixel arrays are separated from each other, the first and second pixel arrays may be driven with the same driving signal, and thus, the first and second pixel arrays may share at least a portion of a display panel driving circuit.

When two pixel arrays AA are divisionally disposed in one substrate, an effect of improving three-dimensionality and various effects may be provided. For example, an arrangement design of the pixel arrays may be freely implemented, and cach of the pixel arrays AA may be disposed at an optimal viewing angle ratio of 1:1 in a left eye and a right eye of a person, thereby increasing three-dimensionality.

When an interval between the pixel arrays AA narrows, a screen size may decrease, and thus, a display image may narrow. When the interval between the pixel arrays AA increases, a center position of the pixel arrays corresponding to both eyes of a user may move to the outer portion of a screen, causing a reduction in three-dimensionality and immersion. When a distance between both eyes of a person is 65 mm and a center point of the pixel arrays AA separated from each other accurately matches both-eye pupils of a user, the user may recognize a stereoscopic image in the personal immersive display apparatus with high three-dimensionality. When an interval between pixel arrays is very narrow or is widened, a viewing angle may be optically compensated for by using a fisheye lens LENS, or a left-eye image and a right-eye image may be adjusted to be suitable for a distance between both eyes of a user through image processing, but such a method may cause a reduction in display efficiency in terms of a viewing angle. In other words, in the present disclosure, when pixel arrays are separated from each other and a center of each of the pixel arrays accurately matches a left-eye pupil of and a right-eye pupil of a user at 1:1, the user may appreciate an accurate stereoscopic image.

In the personal immersive display apparatus, the fisheye lens LENS may be between eyes of a user and a display panel, and a distance between the eyes of the user and the display panel may be several cm and may be very short. In a case where the user watches an image reproduced in the display panels PNL1 and PNL2 by using the fisheye lens, the user may watch an image which enlarges by four to five times a real screen displayed in the display panels PNL1 and PNL2. When a resolution of a display panel is low in a proximity recognition and fisheye lens application environment, a non-emission region of each of pixels may increase, and due to this, a screen door effect may be strongly recognized, causing a reduction in immersion. To increase the immersion of the personal immersive display apparatus, the pixel array of each of the display panels PNL1 and PNL2 may have a resolution of QHD (1440×1280) or more and a pixel density of 500 ppi (pixels per inch) or more and may have a pixel aperture ratio of 14% or more. In 1440×1280, 1440 may be the number of pixels in the horizontal direction x in the pixel array, and 1280 may be the number of pixels in the vertical direction y. Considering technology level of OLED display panels capable of production, the pixel array may have a pixel density of 500 ppi to 600 ppi and a pixel aperture ratio of 14% to 20%.

The personal immersive display apparatus according to the present disclosure may increase a frame rate (or a refresh rate) when displaying a 3D moving image and may thus reduce a sense of fatigue. To this end, the present disclosure may implement a switch element and a driving element of a pixel as an n-type metal oxide semiconductor (MOSFET) in each of the display panels PNL1 and PNL2, and thus, may set a response time of a pixel to less than 2 msec to speed up and may increase a frame rate to 90 Hz or more to advance a data update period. When a frame rate is 90 Hz, one frame period which is a data update period may be about 11.1 msec. Accordingly, in the personal immersive display apparatus, a delay time of the display module 13 may decrease to about 13 msec, and thus, a total delay time may decrease to 25 msec or less. Data of an input image may be addressed in pixels at a data update period.

The personal immersive display apparatus according to the present disclosure may desynchronize a left-eye active time, where a left-eye image is written in a left-eye display, with a right-eye active time where a right-eye image is written in a right-eye display, and thus, may decrease a level of flicker recognized by a user when displaying a 3D moving image. To this end, the present disclosure may set a time difference equal to a certain time between a start timing of the left-eye active time and a start timing of the right-eye active time, or may display a left-eye image and a right-eye image, based on different frame frequencies.

In the present disclosure, the left-eye display may include the first display panel PNL1, and a DIC and a GIP each driving the first display panel PNL1. In the present disclosure, the right-eye display may include the second display panel PNL2, and a DIC and a GIP cach driving the second display panel PNL2.

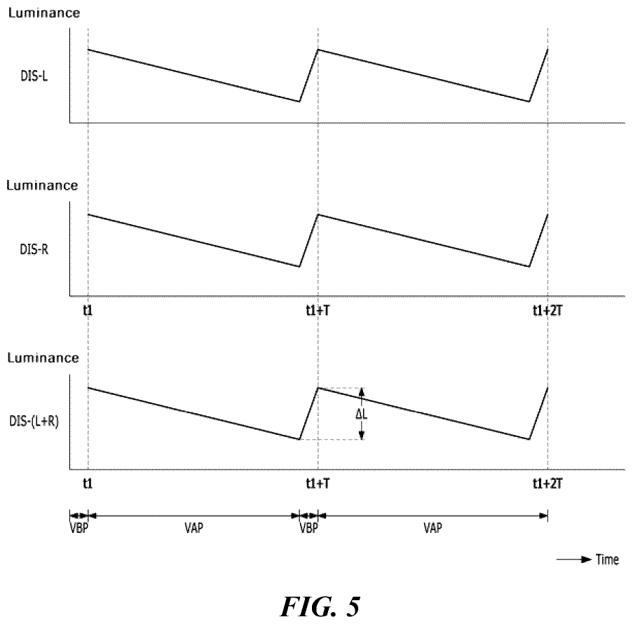

FIGS. 4 and 5 are diagrams illustrating flickers which occur because an image write time of a left-eye display is synchronized with an image write time of a right-eye display, in a comparative example.

Referring to FIG. 4, a left-eye display DIS-L may sequentially display left-eye images A, B, C, and D by using left-eye frames. A right-eye display DIS-R may sequentially display right-eye images A, B′, C′, and D by using right-eye frames.

The left-eye frame may include a left-eye active time VAP and a left-eye blank time VBP, and the right-eye frame may include a right-eye active time VAP and a right-eye blank time VBP. A left-eye image may be written in the left-eye display DIS-L at the left-eye active time VAP, and a right-eye image may be written in the right-eye display DIS-R at the right-eye active time VAP.

Referring to FIG. 5, in each of left-eye frames, a luminance of a left-eye image written in the left-eye display DIS-L may not be constantly maintained due to a leakage current and may decrease in proportion to the elapse of a frame time. Likewise, in each of right-eye frames, a luminance of a right-eye image written in the right-eye display DIS-R may not be constantly maintained due to a leakage current and may decrease in proportion to the elapse of a frame time.

The left-eye active time VAP may be synchronized with the right-eye active time VAP, and the left-eye blank time VBP may be synchronized with the right-eye blank time VBP. Accordingly, in the same frame, a both-eye recognition luminance “DIS-(L+R)” of a user may decrease in proportion to the elapse of a frame time. In the same frame, the both-eye recognition luminance “DIS-(L+R)” of the user may have a difference equal to ΔL, and this may be recognized as flicker by the user.

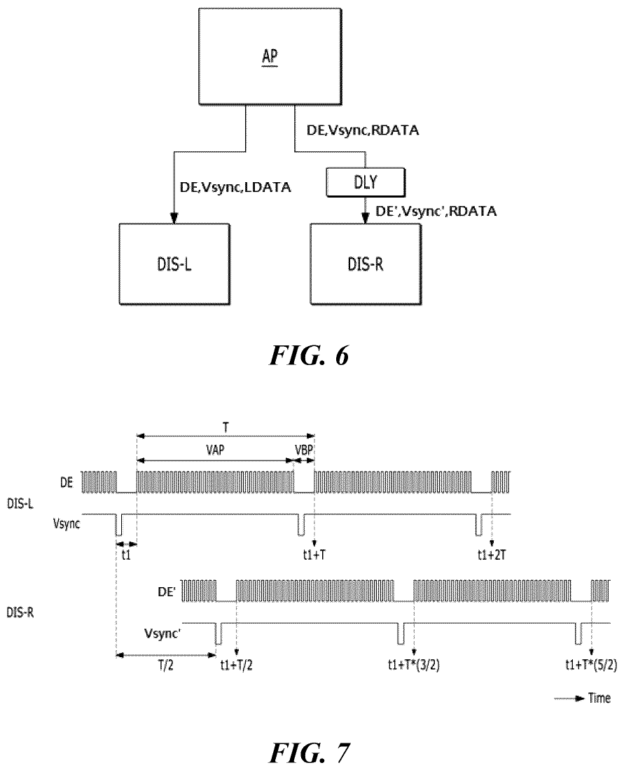

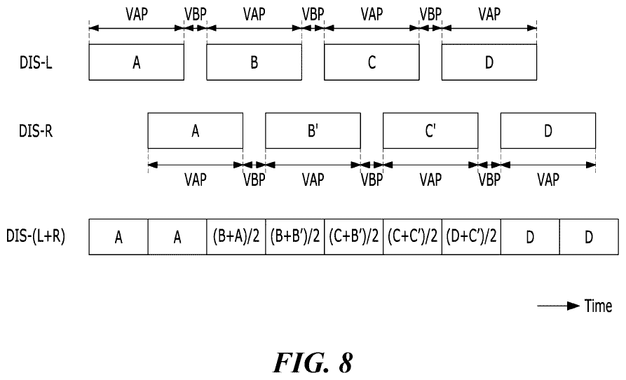

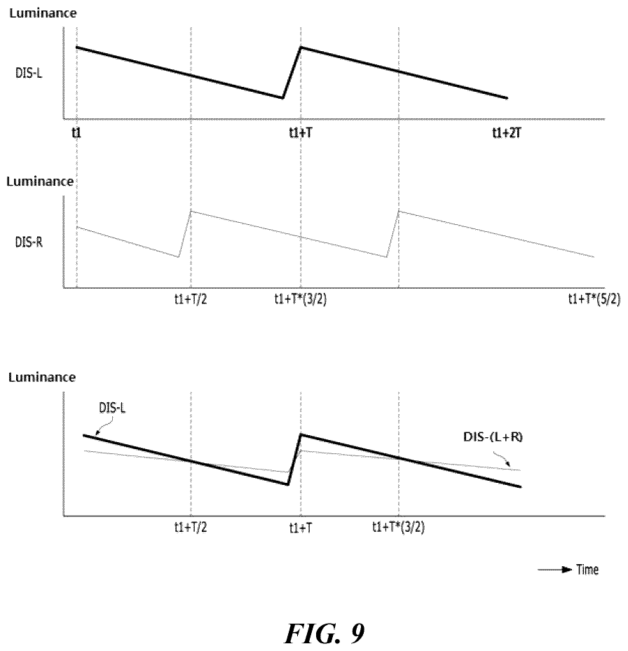

FIG. 6 is a diagram illustrating a configuration of a first embodiment for reducing flickers. FIGS. 7 and 8 are diagrams illustrating an example where a left-eye active time and a right-eye active time are asynchronized with each other by a time difference equal to a certain time therebetween, in an embodiment. FIG. 9 is a diagram illustrating an example where flickers are reduced because a left-eye active time is asynchronized with a right-eye active time.

Referring to FIG. 6, a personal immersive display apparatus according to a first embodiment may include a left-eye display DIS-L for displaying a left-eye image, a right-eye display DIS-R for displaying a right-eye image, a processor AP, and a delay circuit DLY.

The processor AP may generate left-eye image data LDATA corresponding to a left-eye image and a left-eye timing control signal DE and Vsync for controlling a write timing of the left-eye image data LDATA. The processor AP may generate right-eye image data RDATA corresponding to a right-eye image and a right-eye timing control signal DE and Vsync for controlling a write timing of the right-eye image data RDATA.

The delay circuit DLY may selectively delay one of the left-eye timing control signal DE and Vsync and the right-eye timing control signal DE and Vsync. For example, the delay circuit DLY may delay the right-eye timing control signal DE and Vsync and may then supply a delayed right-eye timing control signal to the right-eye display DIS-R. At this time, the left-eye timing control signal DE and Vsync may be supplied to the left-eye display DIS-L without being delayed.

Referring to FIG. 7, the left-eye timing control signal DE and Vsync may define the left-eye active time VAP and the left-eye blank time VBP, and a delayed right-eye timing control signal DE′ and Vsync′ may define the right-eye active time VAP and the right-eye blank time VBP.

The left-eye active time VAP and the right-eye active time VAP may correspond to the same frequency frame. Accordingly, a length of a left-eye frame time T which is a sum of the left-eye active time VAP and the left-eye blank time VBP may be the same as a length of a right-eye frame time T which is a sum of the right-eye active time VAP and the right-eye blank time VBP.

A time difference equal to a certain time may occur between a non-delayed left-eye timing control signal DE and Vsync and the delayed right-eye timing control signal DE′ and Vsync′, and thus, a time difference equal to the certain time may occur between a start timing of the left-eye active time VAP and a start timing of the right-eye active time VAP. In this case, the certain time may be half “T/2” of a left-eye or right-eye frame time T. However, the certain time is not limited to T/2 and may be determined to be a time which is less than T (for example, within a range of 0.1 T to 0.9 T). Considering an effect of reducing flickers, the certain time may in some implementations be T/2. When a difference equal to T/2 occurs between a display timing of a left-eye image and a display timing of a right-eye image, the left-eye image and the right-eye image may be recognized with the both eyes of the user, based on interlace. As a result, a level of flickers recognized with the both eyes of the user may be considerably reduced.

Referring to FIG. 8, a left-eye display DIS-L may sequentially display left-eye images A, B, C, and D by using left-eye frames. A right-eye display DIS-R may sequentially display right-eye images A, B′, C′, and D by using right-eye frames.

The left-eye frame may include a left-eye active time VAP and a left-eye blank time VBP, and the right-eye frame may include a right-eye active time VAP and a right-eye blank time VBP. A left-eye image may be written in the left-eye display DIS-L at the left-eye active time VAP, and a right-eye image may be written in the right-eye display DIS-R at the right-eye active time VAP. Writing of the left-eye image in the left-eye display DIS-L may stop at the left-eye blank time VBP. Writing of the right-eye image in the right-eye display DIS-R may stop at the right-eye blank time VBP.

The left-eye active time VAP may be asynchronized with the right-eye active time VAP, and the left-eye blank time VBP may be asynchronized with the right-eye blank time VBP. That is, the left-eye blank time VBP may overlap the right-eye active time VAP, and the right-eye blank time VBP may overlap the left-eye active time VAP.

As described above, a left-eye image and a right-eye image may be alternated with a time difference equal to a certain time “T/2”, and thus, a greatest deviation of a both-eye recognition luminance “DIS-(L+R)” of a user may decrease within a frame time as in FIG. 9. That is, the greatest deviation of the both-eye recognition luminance “DIS-(L+R)” of the user may more decrease than a luminance deviation of the left-eye display DIS-L or a luminance deviation of the right-eye display DIS-R within a frame time.

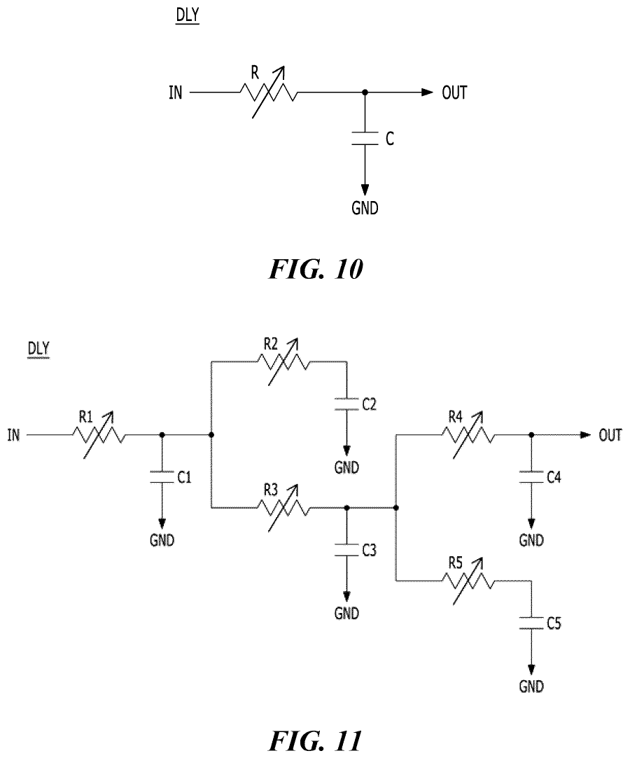

FIGS. 10 and 11 are diagrams illustrating an implementation example of a delay circuit of FIG. 6.

Referring to FIG. 10, the delay circuit DLY of FIG. 6 may be implemented with a single RC circuit including a variable resistor R and a capacitor C. An inter-input/output delay characteristic of the delay circuit DLY may be obtained by adjusting the variable resistor R of the single RC circuit.

Referring to FIG. 11, the delay circuit DLY of FIG. 6 may be implemented with an RC tree circuit including variable resistors R1 to R5 and capacitors C1 to C5. An inter-input/output delay characteristic of the delay circuit DLY may be obtained by adjusting the variable resistors R1 to R5 of the RC tree circuit.

Although not shown in the drawing, the delay circuit DLY of FIG. 6 may be configured with two inverters which are serially connected to each other.

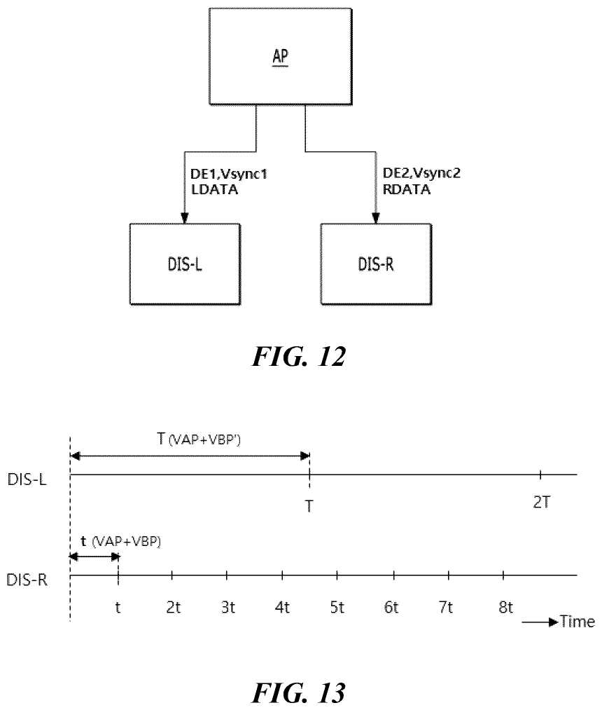

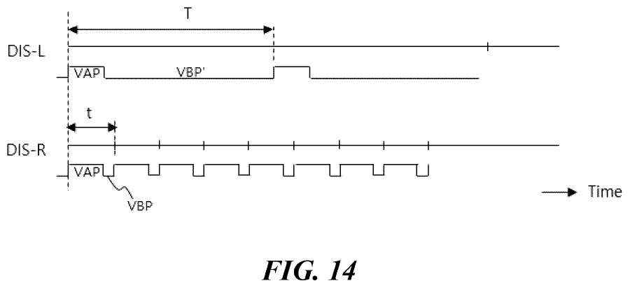

FIG. 12 is a diagram illustrating a configuration of a second embodiment for reducing flickers. FIGS. 13 and 14 are diagrams illustrating an example where left-eye and right-eye displays are driven at different frame frequencies.

Referring to FIG. 12, a personal immersive display apparatus according to the second embodiment may include a left-eye display DIS-L for displaying a left-eye image, a right-eye display DIS-R for displaying a right-eye image, and a processor AP.

The processor AP may generate left-eye image data LDATA corresponding to a left-eye image and a left-eye timing control signal DE1 and Vsync1 for controlling a write timing of the left-eye image data LDATA. The processor AP may generate right-eye image data RDATA corresponding to a right-eye image and a right-eye timing control signal DE2 and Vsync2 for controlling a write timing of the right-eye image data RDATA.

The processor AP may synchronize the left-eye timing control signal DE1 and Vsync1 with a first frame frequency and may synchronize the right-eye timing control signal DE2 and Vsync2 with a second frame frequency. The first frame frequency may differ from the second frame frequency. Accordingly, a length of a left-eye frame time corresponding to the first frame frequency may differ from that of a right-eye frame time corresponding to the second frame frequency.

The left-eye frame time may include a left-eye active time and a left-eye blank time, and the right-eye frame time may include a right-eye active time and a right-eye blank time. The processor AP may vary the first frame frequency, based on an attribute of a left-eye image, and may vary the second frame frequency, based on an attribute of a right-eye image.

For example, when the left-eye display DIS-L displays a see-through background image where an image is hardly changed and the right-eye display DIS-R displays a computer graphics image where an image is largely changed, the processor AP may relatively lower the first frame frequency for the left-eye display DIS-L to decrease power consumption and may relatively increase the second frame frequency for the right-eye display DIS-R to decrease visual fatigue.

Here, when the first frame frequency and the second frame frequency have a non-integer multiple relationship, an effect of reducing flickers recognized with both eyes of a user may be large.

As in FIG. 14, in variable refresh rate (VRR) driving, a length of an active time VAP may be fixed regardless of a frame frequency, and a length of a blank time VBP may vary based on the frame frequency.

A length of a left-eye blank time VBP corresponding to a first frame frequency may be longer than that of a right-eye blank time VBP corresponding to a second frame frequency. A length of a left-eye active time VAP corresponding to the first frame frequency may be longer than that of a right-eye active time VAP corresponding to the second frame frequency.

Accordingly, the left-eye active time VAP may be asynchronized with the right-eye active time VAP, and the left-eye blank time VBP may be asynchronized with the right-eye blank time VBP.

As described above, because a left-eye image and a right-eye image are displayed based on different frame frequencies, a greatest deviation of both-eye recognition luminance of a user may be reduced. That is, the greatest deviation of both-eye recognition luminance of the user may decrease compared to a luminance deviation of a left-eye display or a luminance deviation of a right-eye display for a frame time.

The present disclosure may realize the following effects.

The personal immersive display apparatus according to the present disclosure may desynchronize a left-eye active time, where a left-eye image is written in a left-eye display, with a right-eye active time where a right-eye image is written in a right-eye display, and thus, may decrease a level of flicker recognized by a user when displaying a 3D moving image. To this end, the present disclosure may set a time difference equal to a certain time between a start timing of the left-eye active time and a start timing of the right-eye active time, or may display a left-eye image and a right-eye image, based on different frame frequencies.

The effects according to the present disclosure are not limited to the above examples, and other various effects may be included in the specification.

While the present disclosure has been particularly shown and described with reference to exemplary embodiments thereof, it will be understood by those of ordinary skill in the art that various changes in form and details may be made therein without departing from the spirit and scope of the present disclosure including those of the following claims.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A personal immersive display apparatus comprising:
a left-eye display configured to display a left-eye image; and
a right-eye display configured to display a right-eye image,
wherein a left-eye active time where the left-eye image is written in the left-eye display is asynchronized with a right-eye active time where the right-eye image is written in the right-eye display.

2. The personal immersive display apparatus of claim 1, wherein a left-eye blank time where writing of the left-eye image in the left-eye display stops is asynchronized with a right-eye blank time where writing of the right-eye image in the right-eye display stops.

3. The personal immersive display apparatus of claim 2, wherein the left-eye active time and the right-eye active time correspond to a same frame frequency, and
a time difference is between a start timing of the left-eye active time and a start timing of the right-eye active time.

4. The personal immersive display apparatus of claim 3, wherein, when one frame time based on a same frame frequency is T, the time difference is T/2.

5. The personal immersive display apparatus of claim 4, wherein the left-eye blank time overlaps the right-eye active time, and
the right-eye blank time overlaps the left-eye active time.

6. The personal immersive display apparatus of claim 3, further comprising:
a processor configured to generate a left-eye timing control signal which is to be supplied to the left-eye display and a right-eye timing control signal which is to be supplied to the right-eye display; and
a delay circuit configured to selectively delay one of the left-eye timing control signal or the right-eye timing control signal,
wherein the left-eye timing control signal is configured to control the left-eye active time and the left-eye blank time, and
the right-eye timing control signal is configured to control the right-eye active time and the right-eye blank time.

7. The personal immersive display apparatus of claim 2, wherein a length of a left-eye frame time corresponding to a first frame frequency differs from a length of a right-eye frame time corresponding to a second frame frequency,
the left-eye frame time comprises the left-eye active time and the left-eye blank time, and
the right-eye frame time comprises the right-eye active time and the right-eye blank time.

8. The personal immersive display apparatus of claim 7, wherein a length of the left-eye active time is equal to a length of the right-eye active time, and
a length of the left-eye blank time differs from a length of the right-eye blank time.

9. The personal immersive display apparatus of claim 7, further comprising a processor configured to synchronize a left-eye timing control signal, which is to be supplied to the left-eye display, with the first frame frequency and synchronize a right-eye timing control signal, which is to be supplied to the right-eye display, with the second frame frequency,
wherein the first frame frequency differs from the second frame frequency.

10. The personal immersive display apparatus of claim 7, wherein the first frame frequency and the second frame frequency have a non-integer multiple relationship.

11. A driving method of a personal immersive display apparatus, the driving method comprising:
displaying a left-eye image by using a left-eye display; and
displaying a right-eye image by using a right-eye display,
wherein a left-eye active time where the left-eye image is written in the left-eye display is asynchronized with a right-eye active time where the right-eye image is written in the right-eye display.

12. The driving method of claim 11, wherein a left-eye blank time where writing of the left-eye image in the left-eye display stops is asynchronized with a right-eye blank time where writing of the right-eye image in the right-eye display stops.

13. The driving method of claim 12, wherein the left-eye active time and the right-eye active time correspond to a same frame frequency, and
a time difference is between a start timing of the left-eye active time and a start timing of the right-eye active time.

14. The driving method of claim 12, wherein a length of a left-eye frame time corresponding to a first frame frequency differs from a length of a right-eye frame time corresponding to a second frame frequency,
the left-eye frame time comprises the left-eye active time and the left-eye blank time, and
the right-eye frame time comprises the right-eye active time and the right-eye blank time.
